(19) United States
(12) Patent Application Publication
(10) Pub. No.: US 2020/0302732 A9
(43) Pub. Date: Sep. 24, 2020

(54) GESTURE BASED GAMING CONTROLS FOR AN IMMERSIVE GAMING TERMINAL

(71) Applicant: ROBERT A. LUCIANO, JR., RENO, NV (US)

(72) Inventor: ROBERT A. LUCIANO, JR., RENO, NV (US)

(21) Appl. No.: 15/354,675

(22) Filed: Nov. 17, 2016

Related U.S. Application Data
(63) Continuation-in-part of application No. 15/098,728, filed on Apr. 14, 2016.
Application No. 15/098,728 is a continuation of application No. 13/804,899, filed on Mar. 14, 2013, now Pat. No. 9,339,715.
Application No. 13/804,899 is a continuation-in-part of application No. 13/277,940, filed on Oct. 20, 2011, now Pat. No. 9,339,697.
(60) Provisional application No. 62/256,299, filed on Nov. 17, 2015.

(51) Int. Cl. G07F 17/32; A63F 13/211

(52) U.S. Cl. CPC G07F 17/3206; A63F 13/211; G07F 17/3295; G07F 17/3288; G07F 17/3216; G07F 17/3213; G07F 17/3265; G07F 17/3246; G07F 17/3248; G07F 17/3223; G07F 17/3258; G07F 17/3239; G07F 17/3255

(57) ABSTRACT

A gaming system and method is described. The gaming system includes an immersive gaming terminal, at least one motion sensing sensor, at least one game of chance and at least one game of skill. The immersive gaming terminal includes a floor, a caged perimeter, and a display that occupies a significant portion of the perimeter, the display interfaces with the floor and the caged perimeter. The motion sensing sensor receives a plurality of player gesture gaming inputs. The game of chance is controlled by the at least one player gesture gaming input received by the motion sensing sensor. The game of chance includes a game of chance game session that includes a game of chance prize that is awarded according to a random game session result. The game of skill that is controlled by the at least one player gesture gaming input received by the motion sensing sensor.

### CROSS REFERENCE

This patent application claims the benefit of U.S. Provisional Patent Application Ser. No. 62/256,299, filed Nov. 17, 2015, which is a Continuation in Part of U.S. patent application Ser. No. 13/804,899 filed in Mar. 14, 2013 and entitled RADAR BASED TRACKING SYSTEM GOLF DRIVING RANGE, which is hereby incorporated by reference in its entirety.

### FIELD

The present invention relates to gesture based gaming controls for an immersive gaming terminal. More specifically, this patent application is related to a game session that includes a game of skill and a game of chance, which further includes a random game session result.

### BACKGROUND

Delivering a Virtual Reality (VR) experience requires three component devices, in which the first component includes at least one of a Personal Computer (PC), console, smartphone or other such processing system that runs the application or game. The second component device is a headset which secures a display in front of the user's eyes and some kind of input. The third component device provides inputs that control the VR experience such as head tracking, controllers, hand tracking, voice, on-device buttons, trackpads and other such inputs.

Virtual Reality (VR) headsets are often referred to as Head Mounted Displays (HMDs). The goal of the hardware is to create what appears to be a life size, 3D virtual environment without the boundaries we usually associate with TV or computer screens. In console or PC embodiments, the video is sent from the console or computer to the headset via an HDMI cable or other such cable. In smartphone embodiment, the video is already on a smartphone, which is slotted into a headset. Typically, the headset field of view is 100 ° to 110°. A minimum frame rate of around 60 through 120 frames per second is used to avoid stuttering or users' feeling sick.

Head tracking refers to the process of the following the user's head movements along x, y and z axes. A few different internal components may be used in a head-tracking system such as a gyroscope, accelerometer and a magnetometer. Head-tracking requires low latency of 50 ms or less to be effective. Headphones may also be used to increase the sense of immersion, especially when combined with head tracking technology.

Other illustrative input sources include infrared sensors strapped to the HMD, in which the infrared sensors track hand movements. Another illustrative input source is a wireless controller, which makes the user feel like they are using their own hands in VR. For example, to shoot a gun the user squeezes a trigger on the controller. Additionally, wireless controllers may include sensors to detect gestures such as pointing and waving.

Base stations may also be used to provide sensor inputs. For example, two base stations sweep the area with lasers and detect the precise position of the user's head and hands based on the timing of when they hit each photocell sensor on both the headset and around each handheld controller.

Other input methods can include a controller or joystick, voice controls, smart gloves and treadmills, which allow the user to simulate walking around a VR environment with clever in-game redirections.

Infrared sensors may be also be used for eye tracking inside the headset. The main advantage of monitoring a person's eyes is to make depth of field more realistic. With eye tracking, the graphics engine can simulate this in a 3D space in VR.

There are various limitations to the VR experiences and VR inputs presented above. Most notably, it is difficult for other users to participate or watch the VR user without the help of VR headsets themselves. Additionally, there is the time and difficulty associated with learning to use each of the different input devices that communicate or control the images presented in the head mounted display.

### SUMMARY

A gaming system and method is described. The gaming system includes an immersive gaming terminal, at least one motion sensing sensor, at least one game of chance and at least one game of skill. The immersive gaming terminal includes a floor, a caged perimeter, and a display that occupies a significant portion of the perimeter, and the display interfaces with the floor and the caged perimeter. The motion sensing sensor receives a plurality of player gesture gaming inputs. Additionally, the motion sensing sensor is fixedly coupled to the immersive gaming terminal and communicatively coupled to the immersive gaming terminal. The game of chance is controlled by the at least one player gesture gaming input received by the motion sensing sensor. The game of chance includes a game of chance game session that includes a game of chance prize that is awarded according to a random game session result. The game of skill that is controlled by the at least one player gesture gaming input received by the motion sensing sensor.

In another illustrative embodiment, the gaming system includes a plurality of motion sensing sensors fixedly coupled and communicatively coupled to the immersive gaming terminal. Additionally, the gaming system may include a server communicatively coupled to the immersive gaming terminal; the server includes a database that stores the results from the game of chance and the game of skill.

In yet another illustrative embodiment, the game of skill includes a game of skill game session that includes simulating striking or throwing a ball at a plurality of targets and awarding a skill based prize for having the ball hit at least one of the targets.

In a further illustrative embodiment, the game of chance includes at least one spinning wheel, in which a nudge gesture allows the wheel element to be moved partially. The game of chance may also include at least one spinning wheel, in which a clap gesture determines when to stop or pause the wheel. Additionally, the game of chance includes at least one spinning wheel, in which a flat handed clockwise gesture or a flat handed counterclockwise gesture enables the wheel rotation to increase or decrease.

### DRAWINGS

The present invention will be more fully understood by reference to the following drawings which are for illustrative, not limiting, purposes.

FIG. 1A through 1E show various views of illustrative immersive gaming terminals.

FIG. 2A and FIG. 2B shows the components of an illustrative game of chance.

FIG. 3 shows the components of a networked immersive gaming terminal that includes a game of chance.

FIG. 4 shows an illustrative golf game.

FIG. 5 shows an illustrative racing game.

FIG. 6 shows an illustrative wheel spin game.

FIG. 7 shows an illustrative zombie game.

FIG. 8 shows an illustrative carnival slot game that includes a game of chance and a game of skill.

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the system and method described herein may vary as to configuration and as to details. The following detailed description of the illustrative embodiments includes reference to the accompanying drawings, which form a part of this application. The drawings show, by way of illustration, specific embodiments in which the invention may be practiced. It is to be understood that other embodiments may be utilized and structural changes may be made without departing from the scope of the claims

This patent is directed to combining a game of skill (GoS) and a game of chance (GoC). The game of skill may be performed in a first game session, which is followed by a second game session that includes a game of chance. In another illustrative embodiment, the first game session is a game of chance, which is followed by the second game session that includes a game of skill. Additionally, the game of skill and the game of chance may be performed in the same game session.

The term “game session” is used to refer to a game of chance, a game of skill, or any combination thereof. The various types of game session are also referred to as a “game of chance (GoC) game session,” a “game of skill (GoS) game session,” and the combination of “game of chance/skill (GoCS) game session,” in which order can also be expressed by reference to “game of skill/chance (GoSC) game session.”

The term “game of skill” refers to games where the outcome is determined mainly by mental or physical skill. Many games of skill include an element of chance, but skill plays a greater role in determining the outcome.

An illustrative “game of chance (GoC) game session” includes a game event such as a random game outcome. An illustrative game event initiates the GoC game session when a wager or credits are received or transferred to the game of chance. The GoC game session may also be initiated by other game events including, but not limited to, a player hitting a spin button, a start button, a deal button, or any other such input indicating that the player is desirous of starting the GoC game session.

The illustrative game of chance game session may also include a subsequent game of chance session such as a “bonus game session” or a “second game of chance game session,” which refers generally to a game or a component of a game involving procedures that follow a “first game of chance game session.” Typically, the bonus game session is initiated after the first game of chance game session is completed or after a particular condition has been triggered or satisfied that causes the bonus game session to be initiated. The bonus game session may also include a plurality of bonus game events.

For example, when the illustrative first game of chance game session includes a slot game, the bonus game may allow players the possibility of winning more than the pay table associated with the underlying slot game. Typically, the bonus game outcome depends upon the outcome of the first game of chance game session. For example, a bonus game outcome may depend upon a particular symbol being displayed on a slot reel when one of final game events takes place. Also, the bonus game outcome may depend upon winning a payout from a slot game play while the gaming machine is in a “bonus zone.” In other embodiments, the bonus game may be unconnected with the outcome of a primary game play.

Any of the game sessions may be terminated voluntarily when the player elects to stop the game, or involuntarily when the gaming device terminates the primary game session based on a termination event.

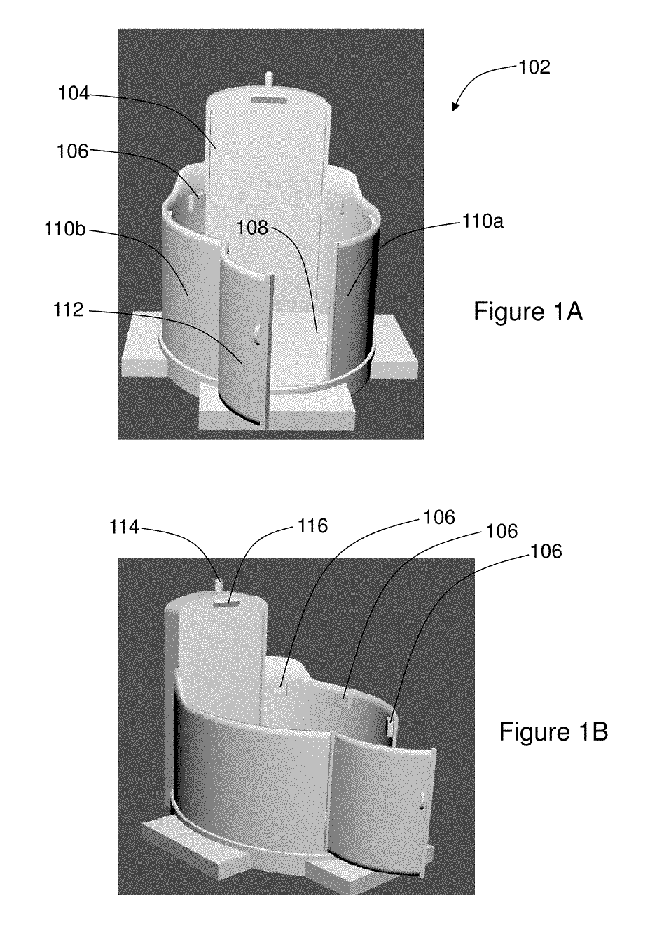

Referring to FIG. 1A through 1E there is shown various views of various illustrative immersive gaming terminals. Each of the immersive gaming terminals shown below provides a form factor for comprehensive player interactivity that allows for game applications that are unique to the gaming industry.

As noted above there are various limitations to the VR experience, which make it difficult for other users to participate or watch the VR user without the help of VR headsets themselves. The immersive gaming terminal provides a form factor with one or more large screens that does not require the use of VR headset but creates an immersive VR-like experience.

There is the time and difficulty associated with learning to use each of the different input devices that communicate or control the images presented in the head mounted display. The immersive gaming terminal presented receives game inputs from player gestures that are identified with one or more sensors. Thus, the player does not have to be fitted with a particular joystick, smart glove, controller or other such sensor that couples to the user's hands.

In FIG. 1A, a front perspective view of the immersive gaming terminal 102 is presented. The illustrative immersive gaming terminal 102 includes at least one display 104. By way of example and not of limitation, the illustrative display 104 is an 80 inch display screen. The display screen may be a touch sensitive screen.

In another illustrative embodiment, the immersive terminal 102 includes two or more display screens that occupy an approximate 120° player field of view or greater than 120° player field of view. The purpose of occupying such a large player field of view is to simulate a VR experience, while preserving the ability to have spectators view the player's interactive experience. This level of interactivity heightens the desire of other players to play the game and also may cause them to enter a nearby immersive gaming terminal.

The immersive gaming terminal includes a surround sound component 106. Floor sensors (not shown) may be disposed throughout the floor 108. In another embodiment, the floor 108 may also include an omnidirectional treadmill. The viewing walls 110a and 110b proximate to the display 104 are composed of a transparent material such as a transparent plastic or glass. Additionally, a transparent door 112 provides access to the immersive gaming terminal. The combination of viewing walls 110 and transparent door 112 enables an observer to view the immersive game session. The combination of the viewing walls and the transparent door define a caged perimeter. The display interfaces with the floor and the caged perimeter. The illustrative immersive gaming terminal may be used in multiplayer and single player applications that are interactive and competitive.

Referring to FIG. 1B, there is shown another perspective view of the immersive gaming terminal 102, in which the surround speakers 106 are shown. A slot candle 114 sits on top of the display 104. An illustrative sensor 116 receives player gesture inputs.

In the illustrative embodiment, the sensor 116 is a motion sensing input device such as a KINECT®, which is a motion controller distributed by Microsoft Corporation. The illustrative sensor 116 is used to interpret specific gestures by using an infrared projector and camera to track the movement of individuals in three dimensions. The illustrative sensor is a remote non-contact sensor that includes time-of-flight cameras or structured light sensors that operates using a structured light that projects an infrared light with a known pattern onto the player and the computer (not shown) proceeds to read the deformation of the pattern optically using a standard or special-purpose camera, e.g. a camera with infra-red filters.

Referring to FIG. 1C and FIG. 1D there is shown a top view and side view, respectively, of another illustrative gaming terminal 120. The illustrative gaming terminal 120 includes three motion sensing input devices 122, 124 and 126 that are disposed on the top of display 128. By way of example and not of limitation, the illustration motion sensing input device is KINECT®.

The first motion sensing device 122 is disposed between motion sensing devices 124 and 126. Additionally, the first motion sensing device 122 principally points vertically, capturing the gestures in gaming terminal space 130. Gaming space 130 captures the gestures that are generated immediately in front of display 128.

In the illustrative embodiment, the other two motion sensing devices 124 and 126 are disposed on each side of first motion sensing device 122. The illustrative motion sensing device 124 (shown in FIGS. 1C and 1D) is pointed at an angle, which captures the gestures from gaming space 132. Motion sensing device 126 is also pointed at an angle that captures the player gestures in gaming space 134 (shown only in FIG. 1C).

The combination of gaming spaces 130, 132 and 134 capture the player gestures within gaming terminal 120. More specifically, the motion sensing devices 122, 124 and 126 capture the player gestures within gaming spaces 130, 132 and 134, respectively.

In one illustrative embodiment, a processor (not shown) that controls the game session receives the gestures from the motion sensing device based on the proximity or resolution of the player gesture. Thus, the gestures which control the games session are captured by one of the illustrative three motion sensing devices; and as the player moves through the gaming terminal 120, different motion sensing devices capture the player's gestures in different locations within the gaming terminal 120. In an alternative embodiment, the gestures captured from a plurality of motion sensing devices are processed by one or more processors so that the game session is controlled by a plurality of motion sensing devices.

Referring to FIG. 1E there is shown another illustrative gaming terminal 150. The illustrative gaming terminal 150 includes an exterior control unit housing 152 that also includes additional game inputs 154. By way of example and not of limitation, the gaming inputs may include a bill validator that receives cash, a wager amount, a gaming voucher (ticket) component and other such gaming inputs.

The illustrative exterior control housing 152 may include the components of a typical console gaming device such as a PlayStation 4®, also referred to as a PS4®, distributed by Sony. A typical console enables interactive skill based game sessions.

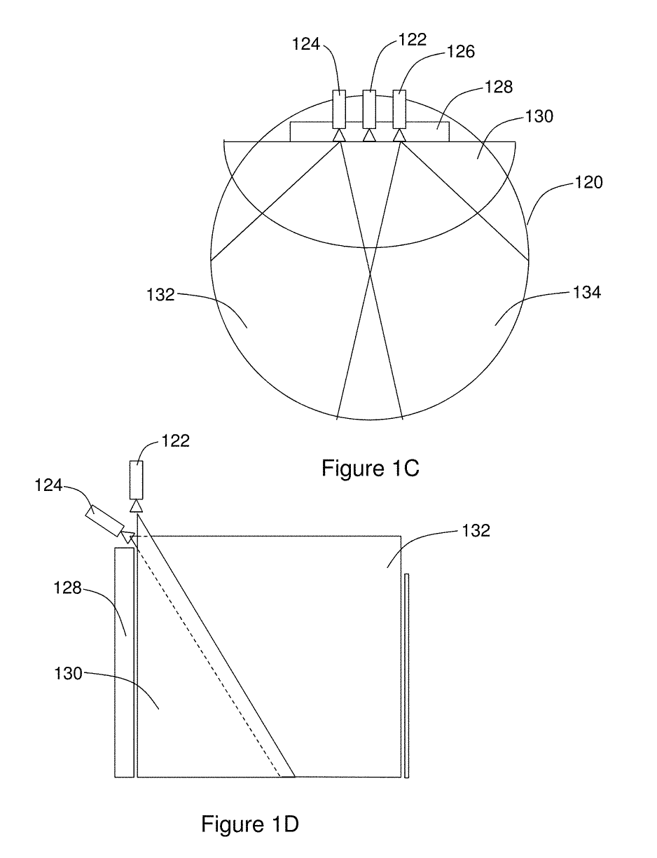

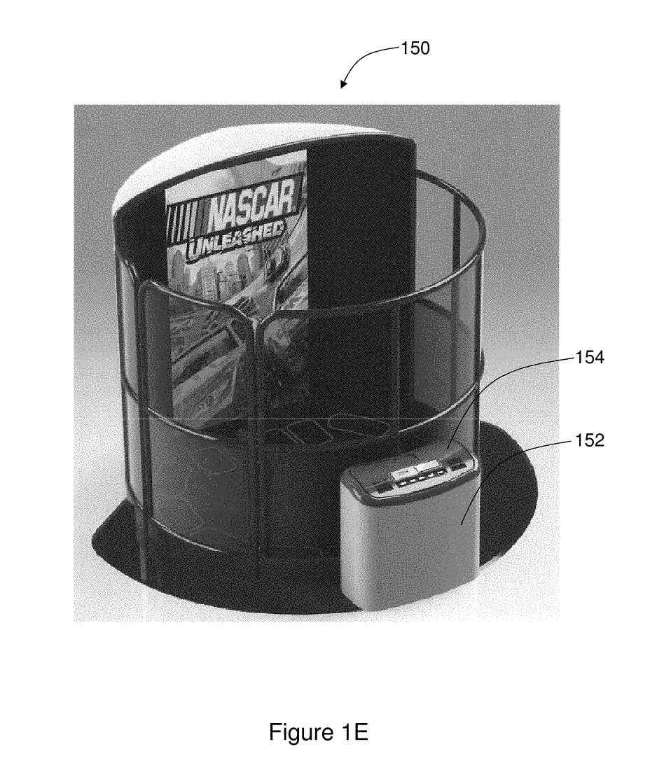

The illustrative exterior control housing 152 may also include one or more of the components associated with a game of chance such as presented in FIG. 2A, FIG. 2B and FIG. 3.

FIG. 2A and FIG. 2B show the components of a typical game of chance which the illustrative exterior control housing 152 may include. In FIG. 2A, there is shown an illustrative stand alone gaming device 200 configured to operate the illustrative game of chance. In the illustrative embodiment, the stand-alone gaming device 200 is an electronic device that has a touch screen video display 202 that displays a player interface. Other electronic devices that could be used to provide an interactive gaming experience include a computer having interactive gaming software, a personal digital assistant, a mobile phone, a smartphone, or any other such device or combination of devices that displays the interactive game. As shown, the illustrative stand alone gaming device 200 may include a handle 204 that acts as a player interface component.

The illustrative stand alone game of chance device 200 may include a monetary input component that is configured to receive money or transferable credits. The illustrative monetary input component 206 is a device configured to receive Ticket In Ticket Out (TITO) tickets, coupons, cash, a credit card, debit card or other such instruments that can transfer money or credits. Additionally, the illustrative monetary input component 206 may also be configured to receive transferable credits from an e-wallet on a smartphone. The transferable credits may be provided by a coupon based system.

A communications module 208 includes various communication channels that can utilize Ethernet, I2C, RS-232, USB, RS-485, IEEE 1394, Netplex and other standard or proprietary communication interfaces used in the gaming industry. These communication channels may operate or interface with wired and wireless communications channels. The communications module 208 may be used to communicate with personal communication devices such as smartphones that operate using Bluetooth wireless technology, Wi-Fi, or other such technologies that enable communications between the electronic gaming device and the personal communication device.

Additionally, the illustrative gaming device may also include other input and output devices 210 such as input buttons, bill validators, card readers, printers, displays, audio devices, bonus devices (e.g., wheels and reels), or lighting devices that are used to provide a wager-based game on the gaming machine. The input and output devices 210 are typically related to distributing awards and include a paper coupon, a smart card, a magnetic stripe card, or any other such means that can record the transfer of money or credits to the player.

Referring now to FIG. 2B there is shown a simplified illustrative block diagram of the illustrative system components 220 of the stand alone gaming device 200. The system components 220 include a logic component that is operatively coupled to internal components that manage the various gaming systems and operations for the interactive gaming device 200. In one illustrative embodiment, the electronic gaming device may include a computer, in which the logic component includes a central processing unit (CPU) 222 and a memory 224 that stores the gaming operations and processes of the interactive game. A fast memory cache 226 may also be employed by the CPU 222 to more efficiently access data or software stored in the memory 224. It shall be appreciated by those skilled in the art that the memory cache is a memory that is resident on the CPU 222. Additionally, it shall be appreciated by those skilled in the art that the logic component does not have to be a CPU and may include a plurality of logic gates and switches that are either programmed, e.g. a field programmable gate array, or may be an application specific integrated circuit (ASIC).

In the illustrative gaming device embodiment, the processor 222 is configured to perform the single reel game operations. Additionally, the gaming device typically includes a network interface card that is communicatively coupled to a network so the gaming device is configured to communicate with the network as presented below in FIG. 3.

Additionally, in the illustrative embodiment a player interface 228 is operatively coupled to the CPU 222. By way of example and not of limitation, the player interface 228 may include a touch screen video display 202 and a handle 204. Alternatively, the player interface 228 may also include a video display (not shown) having a plurality of switches (not shown) that permit the player to interact with the stand alone device 200. Another alternative player interface 228 is a computer monitor (not shown) having a keyboard or mouse (not shown). Preferably, the player interface includes a monetary input component as described above. Thus, the player interface 228 includes any interface that permits the player to interact with the stand alone system and input desired gaming parameters.

In an illustrative embodiment, a random number generator 230 is a software module used in the selection of at least one game selected symbol from a set of game symbols during a game event. The game event is defined as a period during which the at least one game selected symbol is picked from the set of game symbols. A game session is comprised of a plurality of game events. The set of game symbols includes numbers, letters, geometric figures, animated figures, or any combination thereof. In the illustrative embodiment, the random selection of a game selected symbol involves generating a random number and using the random number as a basis for picking at least one game selected symbol from within the set of game symbols. It shall be appreciated by those skilled in the art that the random number generator is typically a software program that is stored in the memory 224 and processed by CPU 222.

Alternatively, the picking of at least one game selected symbol from the set of game symbols may be simulated using systems and methods that provide the appearance of a random selection. By way of example and not of limitation, the appearance of random selection can be created using well known “lottery” based systems and methods.

In another embodiment, the stand alone gaming device 200 may include a network interface card (NIC) 232 that permits the stand alone device 200 to communicate with a plurality of other devices configured to play the interactive game. The NIC 232 may also use well known networking protocols to communicate with other networked devices. These well known protocols include Ethernet type protocol, TCP/IP protocols, or other such network protocols. Additionally, the stand alone devices maybe networked to provide access to a progressive jackpot. The progressive jackpot is a shared jackpot generated from the network of game devices.

Referring now to FIG. 3, there is shown the components of a networked immersive gaming terminal that include a game of chance. An illustrative network system 250 having a plurality of networked devices 252a through 252d. In one illustrative embodiment, the networked devices 252a through 252d are similar to the stand alone device 200.

In the illustrative network system 250, the networked devices 252a and 252b are operatively coupled to a node 254 that communicates with a local area network (LAN) server 256. Additionally, the networked devices 252c and 252d are operatively coupled to a separate node 258 that is communication with a LAN server 260. The nodes 254 and 258 may be a hub, router, bridge, gateway or any combination thereof that allows communications between the networked devices. It shall be appreciated by those skilled in the art that each LAN may operate independently of the other.

A wide area network (WAN) is created by linking the LANs together. For illustrative purposes only, both LANs communicate with a WAN server 262. For purposes of this patent, it can be appreciated that the distinction between a LAN and WAN is primarily geographic in nature. The LAN is geographically limited to a bank of illustrative stand alone gaming devices that may be resident on the casino floor. A WAN permits banks of networked devices from different casino locations to be networked. A primary purpose for networking the gaming devices is to generate a progressive jackpot. Additional reasons for networking include accounting, diagnostics, player tracking, and loyalty programs.

An alternative embodiment to the illustrative network system 250 comprises having the game logic for the interactive game resident on a central server. The central server may be either the LAN server 256 or WAN server 262. During game play, the server communicates game outputs to the appropriate client, i.e. one of the networked devices 252a through 252d. In yet another illustrative embodiment, the central server picks the game selected symbols and submits the game selected symbols to each of the clients on the network.

In another illustrative embodiment, the networked system utilizes the Robust Online Client® (ROC) distributed by Spin Games. The ROC® is a remote gaming server (RGS) and a for-wager game content delivery system designed to streamline the delivery of for-wager gaming content for the interactive market. The ROC development console supports the ability to use HTML5 game engines.

The networked immersive gaming terminal can also read or scan casino gaming vouchers. The illustrative casino gaming voucher is a Ticket-In-Ticket-Out (TITO) ticket. A slot accounting system that manages and monitors the casino gaming voucher transactions. The networked immersive gaming terminal reads a casino gaming voucher and determines a player identity. The networked immersive gaming terminal associates the monetary value from the casino gaming voucher with a casino patron. The slot accounting system transfers the monetary value from the casino gaming voucher to the networked immersive gaming terminal for game play.

The casino gaming vouchers are generated by the networked immersive gaming terminal, slot machines and video lottery terminals that print tickets commonly referred to as “ticket in/ticket out” or “TITO” tickets. A TITO ticket is a gaming instrument issued by a slot machine or video lottery terminal to a customer as a record of the wagering transaction and/or substitute for currency. Tickets are voucher slips printed with the name and the address of the gaming establishment, the stated monetary value of the ticket, date and time, machine number (i.e., asset or location), an 18-digit validation number, and a unique bar code. Tickets are a casino bearer “IOU” instrument. A customer can use a ticket at a machine or terminal that accepts tickets, cash, a ticket at a cage, slot booth, a redemption kiosk, or a pari-mutuel window at the gaming establishment.

The illustrative network system 250 may also include a database configured to store additional information associated with a player including, but not limited to, a record of the player's play history, transactional information, and account information. The player and other information associated with the player may be stored on a card having a magnetic stripe or other readable media. The database of points for the active player is then displayed in a game format on the tablet and display at the booth, on a website, and various displays throughout the facility (like a leader board).

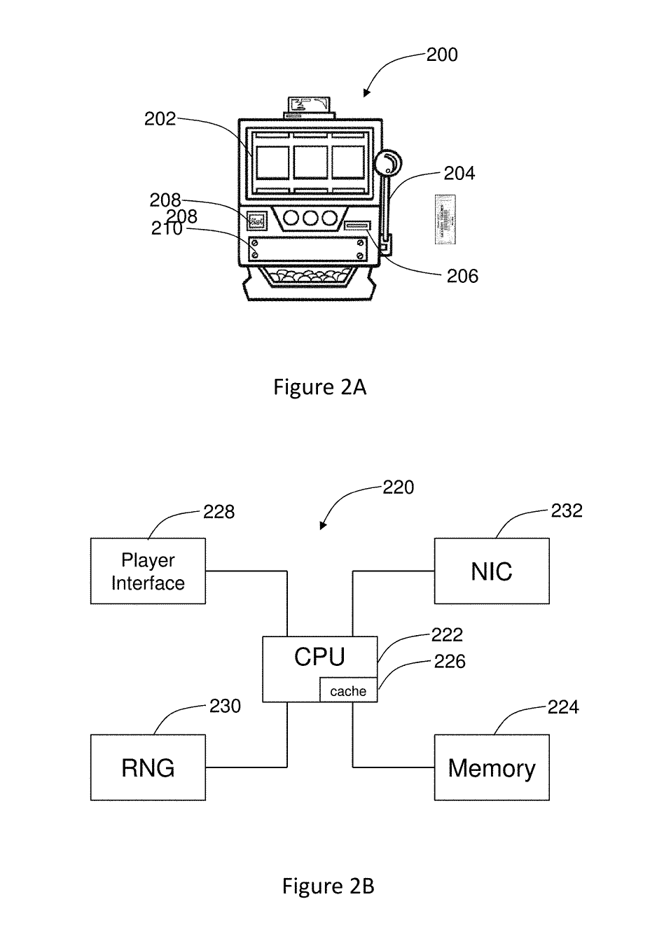

Referring to FIG. 4 there is shown an illustrative golf game 300. The golf game 300 may operate in a manner similar to patent application Ser. No. 13/804,899 filed on Mar. 14, 2013 and entitled RADAR BASED TRACKING SYSTEM GOLF DRIVING RANGE. For example, the illustrative golf game 300 may include a screenshot of the ball trajectory after a golf ball is struck by a player. The golf game 300 may also present additional tabs or information such as an add credits tab, an add/remove player tab, a view all score tab and an end game tab.

After the golf ball lands in the driving range, the system and method may determine whether the player has landed in the target area. For example, if the golf ball lands in one of the multiple portable or stationary targets on the driving range, the player is awarded points based on the distance away from the pin. This target area is presented as a plurality of concentric circles surrounding the pin.

If the player lands in one of the hazards on the playing field, negative points may be awarded and displayed on the game user interface, and the total player points are decremented accordingly.

A game of skill may be played by a group of players, in which each player has an opportunity to strike a golf ball, hit a target and be awarded points for having their golf ball land in a target area. Thus, after a first player's information is displayed, the first player's turn is finished and the next player can then attempt to have his golf ball land in one of the target areas. Each player's game information may be stored in a web accessible website and database that allows each player to go to the website and view his past performance for the different games played.

In operation, the player obtains gaming credits, selects a game and scans his or her player loyalty card before they enter the immersive gaming terminal. More players can join the game via a gaming server communicatively coupled to a plurality of different immersive gaming terminals, thereby allowing for other players from other locations to play against one another.

The game session is initiated when the player enters the immersive gaming terminal and a virtual golf ball is dispensed to the player. The illustrative immersive gaming terminal includes a touch screen display that allows a player to interact with a game selection module that may include at least one game of skill, in which an award is provided when the golf ball associated with the player is read by a target capture area. By way of example and not of limitation, the award may be a predetermined number of points based on the distance and size of the capture area.

Wagering can and will be added in locations that allows for this. For example, the game of skins or Nassau can be played against other users in the same bay, against users in another bay, against users in other bays at other locations, or against a house pool of funds.

The game selection module may also include at least one dedicated game of chance, in which a game session for the game of chance is initiated when the golf ball associated with the player is dispensed. After a random result for the game session is generated, a paytable associates a prize with the random game session result. The awarded prize is then displayed to the player.

In another illustrative embodiment, the game selection module includes a game that has both a first game of skill component and a second game of chance component. In operation, the illustrative combined embodiment starts with the player hitting the ball in the target area and getting points, and then a subsequent game of chance is initiated. By way of example and not of limitation, the game of chance may include having the player spin a wheel for additional points.

In yet another illustrative embodiment, a game session includes a first game of skill that provides a first award when the golf ball is received within a capture area; this first award is based on the player's skill in hitting the ball at the appropriate target. The player then has the opportunity to play a first game of chance such as a slot machine game with one or more reels. Other first games of chance include, but are not limited to, a virtual scratcher, bingo card, lottery game or other such graphic representation of a game of chance. The first game of chance is then followed by a second game of chance such a bonus game. By way of example and not of limitation, the second game of chance is a bonus game that involves having the player spin a wheel. The random prize corresponding to the spinning wheel is then awarded to the player.

In yet another illustrative game embodiment, after a predetermined number of misses by the player, e.g. after 20 balls have been struck but none landed in the target area, the game session for the game of chance is initiated. Therefore, the player can continue to play the game and win points, even if he or she lacks the skill necessary to strike the golf ball and hit the target.

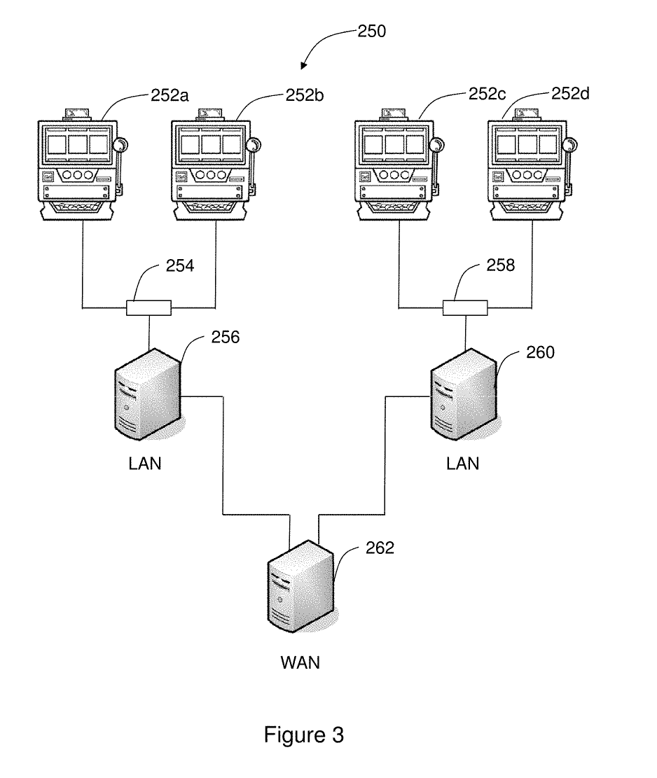

Referring to FIG. 5 there is shown an illustrative racing game 320, which can also be controlled with gestures. The racing game may be directed to a “vehicle” such as a car, motorcycle, bicycle, ATV or other such vehicle. The player gestures that control the vehicle include the hand gestures and changes in the player's center of mass. For example, in a motorcycle or bicycle embodiment, the player needs to simulate leaning in a particular direction when negotiating a sharp turn. Hand gestures may include shifting gears. Braking may be performed with hand gestures, foot gestures or the combination thereof.

The illustrative skill based racing game may also be combined with a game of chance. For example, each time a player completes a lap, the player may win game of chance credits; thus, the more skill the player exhibits during the skill based game session the more opportunities the player has to play the game of chance and win substantially more credits or other such prizes.

The illustrative game of chance may include a first game of chance, e.g. a slot machine game, which is then followed up by a second game of chance, i.e. a bonus game, in which an illustrative wheel is spun.

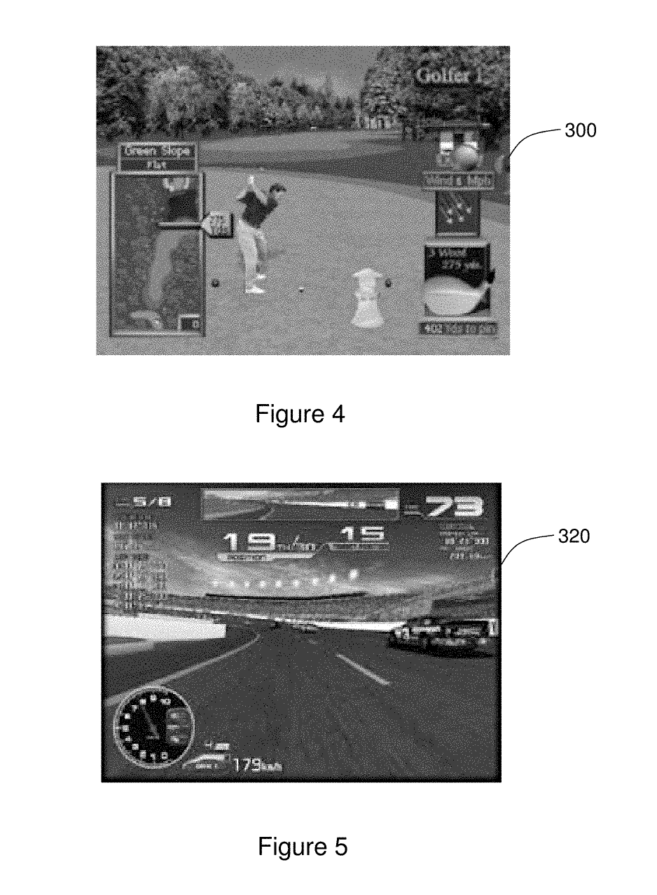

Referring to FIG. 6 shows an illustrative wheel spin game 340 that includes a giant slot machine with three giant reels 342, 344 and 346. In the illustrative skill based game session, the player grabs one or more of the giant reels and pulls the reels downwardly to spin the wheels. During the skill based game session, the player's physical motion, i.e. gestures, are translated into a skill based gaming input. For example, a player may be able to nudge wheel elements so the player can achieve a winning outcome. The wheel spin game may also include wild card symbols that the player can selectively control to obtain a prize. To stop or pause the wheel, the player may clap.

During the skill based game session for the wheel game, the player's gestures control the skill based game session. In addition, to be able to “nudge” the wheels, the player may pause or stop one or more wheels by clapping. Another illustrative gesture includes a flat handed “wax on” clockwise gesture, and flat handed “wax off” counterclockwise gesture. The wax on and wax off gestures can be used to slow or speed up the highlighted reels. After the skill based game session is completed, a game session for a game of chance may be initiated; the illustrative game of chance may include spinning the wheel 348.

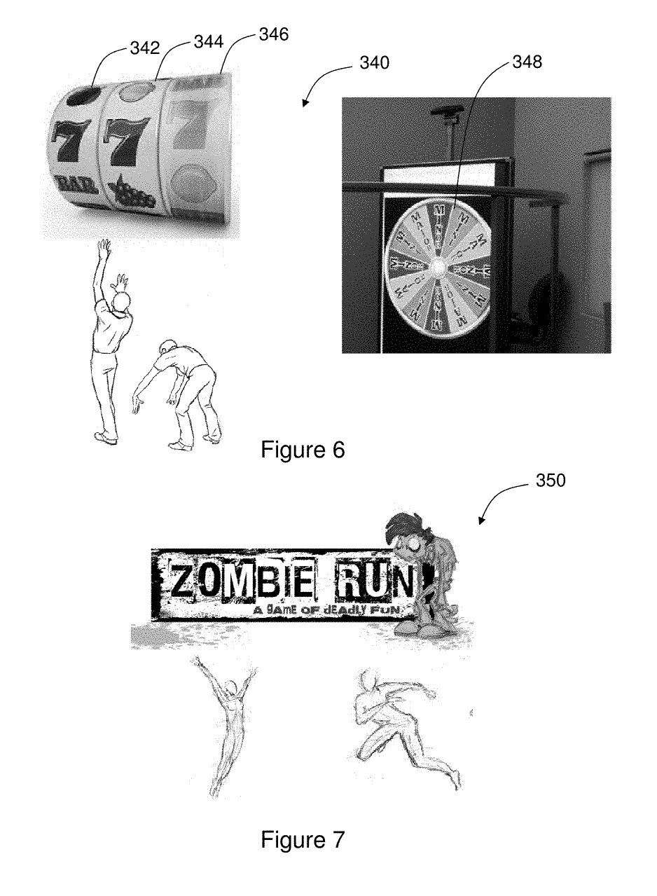

Referring to FIG. 7, there is shown an illustrative zombie game 350 called “Zombie Run,” which is an interactive slot party game. During the zombie game 350, players dodge and defeat zombies while they play for cash and compete for high scores. The gestures captured by the motion sensing device include dodging, ducking, jumping and fighting the hordes of zombies. Additional gestures include a pump action shotgun gesture that can be used for shooting the zombies. Player skill is tracked and the amount time it takes to complete the zombie run affects the player's score; thus, the faster the player dispatches zombies, the higher the player's score. Additionally, the number of zombies that are dispatched during the game session also affects the player score.

The zombie run may also include a game of chance component within the skill based game session. The game of chance may include a separate set of gestures such as the playing bongos gesture, which causes zombies to explode into piles of gory cash. Additionally, the zombie game may include at least one “safe zone,” in which the player can participate in at least one game of chance with one or more players; for example, the safe zone may include casino style games of chance that can provide some respite from the zombie horde.

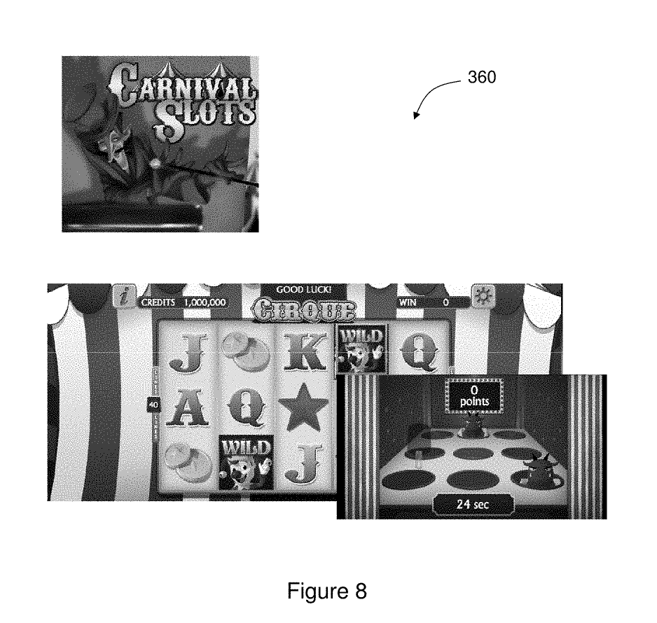

Referring to FIG. 8 there is shown an illustrative skill based game combined with a slot machine game. More specifically, the carnival slots game 360 combines the skill based games in a carnival with a slot machine. When the carnival curtain opens, the game session is initiated and the player is ready to play. The types of skill based games that can be played include shoot the freak, kissing booth, fishing for ducks, mallet swing, ping pong fishbowl and other such games of skill, which also include an element of chance.

Skill based game sessions and game of chance sessions may be controlled by a player's gestures. Illustrative game input gestures may include clapping, a flat handed “wax on” clockwise gesture, a flat handed “wax off” counterclockwise gesture. Player clapping may be used to spin, pause or stop the wheels for a game of chance. Wax on and wax off gestures can be used to slow or speed up the highlighted reels.

The skill based game session may be integrated with the game of chance so that the game of skill operates within the game of chance. For example, the first game session is a “carnival” slot game, which is then followed by a game of skill that affects the outcome of the prize awarded in the slot game. More specifically, the player must first be awarded a prize in the carnival slot machine, which entitles the player to participate in a game of skill, such as whack-the-evil-devil-mole; the greater the skill in the whack-the-evil-devil-mole the greater the multiplier for the prize awarded in the first carnival slot game.

The skill based gaming embodiments presented above may be used in combination with Class II and Class III electronic gaming machines or devices. The Class II gaming devices include bingo and bingo-like games such as pulltab games. Electronic Class II games may be played on a networked gaming machine. Class II gaming machines are networked to a Class II game service and to a player tracking server. Slot machines which operate in Class II jurisdictions may also be known as Video Lottery Terminals (VLT). A VLT plays a virtual lottery game. In some VLT versions, the machine receives a virtual scratch-off ticket. The video reels spin and reveal results consistent with what is on the ticket. In other versions, the machine plays a virtual bingo game and receives a bingo card from a central computer, and various linked terminals play the bingo game to conclusion. The video reels spin and reveal results consistent with what occurred in the bingo game. VLTs are computer terminals linked to central deterministic computers and the games necessarily are generated and played by a Random Number Generator.

Additionally, Class II gaming devices utilize the game of bingo as the basis for determining a winning outcome where the ball draw is performed remotely by a network or central determination server. Class II gaming systems are commonly referred to as central determination systems wherein pools and sub-pools of game outcomes are determined by a central server or gaming device, and distributed amongst a set of networked gaming devices. The distribution step may be on-demand, such as when a gaming device receives a game request, or sets of game outcomes may be distributed to the various networked gaming devices, in which case the game processor of the requesting gaming device may select a game outcome from the set of game outcomes.

The skill based gaming embodiments presented above may also be utilized in Class III games, which are a separate category of gaming machines that are subject to stricter approval and regulation. Generally, Class III games include a gaming machine that has a true random number generator. By way of example, Class III games are networked to a player tracking server, but are not networked for the primary game session, and the primary game session in Class III gaming is typically provided in a stand-alone mode.

Class III gaming devices use an individual internal Random Number Generator (RNG) to determine wins and losses. Every Class III reel spin is separate from any other and payable immediately. The Random Number Generator is generally a program or algorithm which resides in the Central Processing Unit of the gaming device.

It is to be understood that the detailed description of illustrative embodiments are provided for illustrative purposes. Thus, the degree of software modularity for the transactional system and method presented above may evolve to benefit from the improved performance and lower cost of future hardware components that meet the system and method requirements presented. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A gaming system comprising:
an immersive gaming terminal that includes a floor, a caged perimeter, and a display that occupies a significant portion of the perimeter, the display interfaces with the floor and the caged perimeter;
at least one motion sensing sensor that receives a plurality of player gesture gaming inputs, the motion sensing sensor fixedly coupled to the immersive gaming terminal and communicatively coupled to the immersive gaming terminal;
at least one game of chance that is controlled by the at least one player gesture gaming input received by the motion sensing sensor, wherein the game of chance includes a game of chance game session that includes a game of chance prize that is awarded according to a random game session result; and
at least one game of skill that is controlled by the at least one player gesture gaming input received by the motion sensing sensor.

2. The gaming system of claim 1 further comprising a plurality of motion sensing sensors fixedly coupled and communicatively coupled to the immersive gaming terminal.

3. The gaming system of claim 1 further comprising a server communicatively coupled to the immersive gaming terminal, wherein the server further comprises a database that stores the results from the game of chance and the game of skill.

4. The gaming system of claim 1 wherein the game of skill includes a game of skill game session that includes simulating striking or throwing a ball at a plurality of targets and awarding a skill based prize for having the ball hit at least one of the targets.

5. The gaming system of claim 1 wherein the game of chance includes at least one spinning wheel, in which a nudge gesture allows the wheel element to be moved partially.

6. The gaming system of claim 1 wherein the game of chance includes at least one spinning wheel, in which a clap gesture determines when to stop or pause the wheel.

7. The gaming system of claim 1 wherein the game of chance includes at least one spinning wheel, in which a flat handed clockwise gesture or a flat handed counterclockwise gesture enables the wheel rotation to increase or decrease.

8. A gaming system comprising:
a plurality of immersive gaming terminals, in which each immersive gaming terminal includes a floor, a caged perimeter, and a display that occupies a significant portion of the perimeter, the display interfaces with the floor and the caged perimeter;
a plurality of motion sensing sensors corresponding to each immersive gaming terminal, in which each motion sensing sensor receives a plurality of player gesture gaming inputs, the plurality of motion sensing sensors fixedly coupled to the immersive gaming terminal and communicatively coupled to the immersive gaming terminal;
a server communicatively coupled to the immersive gaming terminal, wherein the server further comprises a database that stores the results from a game of chance and a game of skill;
at least one game of chance that is controlled by the at least one player gesture gaming input received by at least one motion sensing sensor; and
at least one game of skill that is controlled by the at least one player gesture gaming input received by at least one motion sensing sensor.

9. The gaming system of claim 8 wherein the game of skill includes a game of skill game session that includes simulating striking or throwing a ball at a plurality of targets and awarding a skill based prize for having the ball hit at least one of the targets.

10. The gaming system of claim 8 wherein the game of chance includes at least one spinning wheel, in which a nudge gesture allows the wheel element to be moved partially.

11. The gaming system of claim 8 wherein the game of chance includes at least one spinning wheel, in which a clap gesture determines when to stop or pause the wheel.

12. The gaming system of claim 8 wherein the game of chance includes at least one spinning wheel, in which a flat handed clockwise gesture or a flat handed counterclockwise gesture enables the wheel rotation to increase or decrease.

13. A gaming method comprising:
receiving a plurality of gesture gaming inputs from at least one motion sensing sensor, wherein the motion sensing sensor is fixedly coupled and communicatively coupled to an immersive gaming terminal that includes a floor, a caged perimeter, and a display that occupies a significant portion of the perimeter, the display interfaces with the floor and the caged perimeter;
controlling at least one game of chance with at least one player gesture gaming input received by the motion sensing sensor, wherein the game of chance includes a game of chance game session that includes a game of chance prize that is awarded according to a random game session result; and
controlling at least one game of skill with at least one player gesture gaming input received by the motion sensing sensor.

14. The gaming method of claim 13 further comprising fixedly coupling and communicatively coupling a plurality of motion sensing sensors to the immersive gaming terminal.

15. The gaming method of claim 13 further comprising communicatively coupling a server communicatively to the immersive gaming terminal, wherein the server further comprises a database that stores the results from the game of chance and the game of skill.

16. The gaming method of claim 13 wherein the game of skill includes a game of skill game session that includes simulating striking or throwing a ball at a plurality of targets and awarding a skill based prize for having the ball hit at least one of the targets.

17. The gaming method of claim 13 wherein the game of chance includes at least one spinning wheel, in which a nudge gesture allows the wheel element to be moved partially.

18. The gaming method of claim 13 wherein the game of chance includes at least one spinning wheel, in which a clap gesture determines when to stop or pause the wheel.

19. The gaming method of claim 13 wherein the game of chance includes at least one spinning wheel, in which a flat handed clockwise gesture or a flat handed counterclockwise gesture enables the wheel rotation to increase or decrease.
